(19) United States
(12) Patent Application Publication
(10) Pub. No.: US 2007/0077403 A1
(43) Pub. Date: Apr. 5, 2007

(54) Cleaning pad laminate

(76) Inventors: John Litvay, Downington, PA (US); Michael F. Kalmon, Boyertown, PA (US)

Correspondence Address: GOSZ AND PARTNERS, LLP, 450 BEDFORD STREET, LEXINGTON, MA, 02420, US

(21) Appl. No.: 11/241,778

(22) Filed: Sep. 30, 2005

(51) Int. Cl. B32B 27/14; D04H 3/05

(52) U.S. Cl. 428/196; 442/366; 428/198; 442/415

(57) ABSTRACT

The instant invention discloses the use of tow fibers in making a cleaning pad laminate for the mops. The opened fibers in the tow are substantially un-bonded to each other except at their lateral edges. The layer of tow fibers provides scrubbing propertied as well as a voluminous area in which the scrubbed particles can settle down. The layer can also act as a wicking layer for the liquids.

The present invention relates to the field of mops and other cleaning equipments. More particularly the invention relates to cleaning pad laminates that are used to clean the surface and still more particularly to laminates that employ the use of opened polypropylene tow as one of the layers.

Cleaning mops that are used either manually or in a machine-assisted manner to wipe, scrub and clean various kinds of surfaces have evolved over a period of time. From the time of ringer bucket mops the technology today has progressed to machines that take care of the mopping and cleaning function.

At a very broad level these mops have three functions i.e. scrubbing the floor, wiping the floor of any dirt and other deposit, and wiping and absorbing excess liquid (either deposited on the surface or the cleaning liquid used for mopping). A lot of technological innovation has been done into the development of the cleaning pad that is used for mopping purposes.

This innovation has resulted in the use of specific materials as per the property of the surface that is to be cleaned. For example soft materials having less of scrubbing properties and more of no-lint property may be suitable for cleaning glass surfaces whereas materials having protruding ends may be better suited for cleaning stones and other surfaces having pores and depressions.

To provide for efficient cleaning, these cleaning pad laminates are often made of one or more layer of materials, each layer serving a specific function in the cleaning process. Usually the bottom most layer i.e. the layer that comes into contact with the surface to be cleaned is slightly abrasive so that it can scrub and remove stains etc. It is obvious that the degree of abrasiveness is dependent on the surface to be cleaned. For instance a coarse cloth may be sufficient for cleaning glass. However, for an unpolished stone surface a thin metal mesh may be required.

Usually the cleaning mop also has a layer of absorbent material that is useful in absorbing the liquid on the surface as well as cleaning up the excess washing fluid (detergent or other suitable composition).

Sometimes between this scrubbing and absorption layer, a layer of 3-Dimensional film may be placed so as to control and regulate the flow of liquid in and out of the absorbent layer. It is desirable to have the liquid to flow into the core and not out of it. This is especially required once the mop is pressed in the downward direction for cleaning purposes. The 3 dimensional holes that are usually tapered in one direction acts as valves and prevent the flow of liquid in the reverse direction i.e. from the absorbent layer to the outside the cleaning pad. These films also provide space for dirt and other particulate matters to accumulate.

Apart from the above, various modifications have been done to improve the functionality and longevity of the cleaning pads. U.S. Pat. No. 6,766,522; U.S. Patent Publication No. 2005/0022483 and U.S. Patent Publication No. 2004/0068817 are some of the recent improvements in the field of cleaning mops.

U.S. Pat. No. 5,614,283; U.S. Patent Publication No. 2002/0062113; U.S. Patent Publication No. 2002/0132521; U.S. Pat. No. 5,085,928; U.S. Statutory Invention Registration No. H1565 disclose various types of absorbent articles that have better fluid absorbent capacity and longer retention duration. They also disclose how to distribute the liquid to be absorbed over the full area of the absorbent core so as to increase the core's usage time and thereby save upon costs. These absorbent cores can be suitably adapted so as to be used in the various mops to suit the needs of any specific application.

Although many of the above tackle issues such as high absorbent and retaining properties, prevention of reverse flow of the absorbent liquid, distribution of the fluid to the full area of the cleaning pad/absorbent core, there are still certain properties that are yet left desired for in mop cleaning pad laminates.

Since most of the present-day cleaning pad laminates are formed with an airlaid serving as the absorbent layer, the laminates absorb liquid with little pressure applied to them. This property is sometimes undesirable as it results in a saturated pad in a very small period of time.

Furthermore conventional absorbent layers merely act as a reservoir for retention of liquids and a separate scrubbing layer has to be used for the actual cleaning operation. The kind of materials that are presently used in the scrubbing layers are meshes and thick polymer or wire bunches that not only have a tendency to clog and get saturated with particulates such as dust etc. but also increase the overall cost of the laminate because of the additional layer.

For the aforementioned purpose a layer made from loose fibers would serve the purpose. The material chosen for the layer can be as per the application but certain qualities like low cost, easy availability etc. are desirable.

Nonwoven waddings and the like can be used as a layer in the absorbent pad. However, such materials may not be a cost effective solution.

Tow is the term used for commercially available crimped, rope like bundles of continuous, extruded organic filaments. The individual filaments in the tow contact each other over a substantial portion of their length, making the tow, a highly dense product. Various techniques are used to open the tow so as to make a lofty array. Those techniques include stretching the tow lengthwise under tension, blowing air through the tow, and using pneumatic tow blooming tools. Some of the patents that explain such processes are U.S. Pat. No. 4,435,239, U.S. Pat. No. 2,926,392.

Tow has found successful application in the cigarette industry where it has been used in cigarette filters because of its filtering properties and hence providing a larger surface area in which carbon and tar particles can be deposited.

In recent years, tow has also been used as a constituent in cores for absorbent articles such as infant diapers, adult incontinence products etc. It has also found applications in cleaning pad laminates for mops. We shall now mention some of the various applications in a little more detail.

U.S. Patent Publication No. 2002/0087136, U.S. Patent Publication No. 2002/0035352, U.S. Pat. No. 6,888,045, U.S. Pat. No. 6,660,902 disclose absorbent articles having a core that is substantially made of tow fibers that are loosely attached to each other. This kind of core has a much higher acquisition rate and is also much more comfortable to wear on the body. Additionally, such cores are well suited for repeated wettings in a short span of time. Tow fibers cores also have increased strength and a longer life than conventional cores.

U.S. Pat. No. 4,991,362 to Heyer et al, discloses a low-density non-woven abrasive pad that is used for scouring purposes. The invention uses organic filaments that are fluffy in nature and are bonded in bunches on their extreme edges. The bunch that is bonded at its edges forms an article that is useful for scouring purposes. Because of its fluffy nature the scooped particles settle down.

U.S. Pat. No. 6,319,593 to Kenmochi et al, discloses a cleaning sheet made of a bundle of filaments that are oriented in one direction and bonded to each other in a pattern. The cleaning sheet is used in mops that are designed to clean surfaces. However the layering and size of the filaments disclosed is useful only for dusting and other less abrasive kind of cleaning. The disclosed sheet is not rough and sturdy enough to be used in a scrubbing application. It would also wear very fast.

U.S. Pat. No. 6,554,937 to Kenmochi et al, discloses a process for making disposable wipe-out sheets that are used to clean and wipe surfaces of the dirt that is deposited on them. Here too tow is used for its property of being fluffy and smooth but the invention has the limitation of doing heavy-duty work.

None of the above mentioned documents or other products being used in the field discloses a mop cleaning pad laminate that is both useful as a scrubbing layer and has high absorbent properties. The product should be such that it does not undergo very fast wear and tear during normal course of usage.

The aforementioned drawbacks make it desirable to have a layer in the absorbent pad laminate that absorbs liquid only on the application of suitable amount of pressure.

It is also desired to have a dual-purpose layer that acts not only as a reservoir to absorb and retain fluids but also has certain scrubbing properties.

Another desired characteristic for mop laminates is to have a layer that is not too abrasive in its scrubbing properties so as to avoid scratches etc.

Furthermore it is desirable to have a layer that acts as a facilitator to pick up solid particles and hold the same without re-depositing the particles back onto the surface that is being cleaned.

It is also desirable that the layer should have a large surface area within the dimensions of the cleaning pad.

### SUMMARY OF THE INVENTION

To achieve the aforementioned objectives and to overcome the drawbacks of the prior art, the present invention provides for a cleaning pad laminate that has a layer of opened fibers that are more or less un-bonded to each other.

This opened tow and has a greater surface area, which is an intrinsic property of the material which allows the dirt particles to be captured. The fiber strands form an uneven surface when the cleaning pad is used because the strands are not bonded to each other thus aiding in scrubbing stains, dirt and other particulate matter from the surface that is being cleaned.

The invention employs the use of synthetic or natural fibers or a combination of both so as to achieve the desired properties of scrubbing, abrasiveness etc. The layer can be used as the bottom-most layer, that is the layer that touches the surface to be cleaned, and hence serve as the scrubbing wiping layer.

This kind of layer can also be used as an intermediate layer collecting dust and other particulate material as well as serving as the absorbent layer.

### BRIEF DESCRIPTION OF THE DRAWINGS

FIG. 1 shows a stack of crimped tow fibers.

FIG. 2 shows a stack of fibers that are bonded at their lateral edge.

FIG. 3 shows a cleaning pad laminate as per one embodiment of the invention.

FIG. 4 shows a cleaning pad laminate as per another embodiment of the invention.

FIG. 5A-5F show some of the bonding patterns that can be formed on the tow fibers. FIG. 6 shows one variable density-bonding pattern.

### DETAILED DESCRIPTION OF THE INVENTION

The invention will now be explained with reference to the accompanying drawings.

A cleaning pad laminate usually has two or more layers. The bottom most layer that comes into the contact with the surface to be cleaned is slightly abrasive in nature so as to have a scrubbing effect. The pads usually have one or more layers that are made of absorbent materials that absorb liquids and excess cleaning fluid from the surface to be cleaned. The choice of the materials is a decision that is based on factors like the surface for which the cleaning pad is to be used, the desired life, and the cost-factor.

These implements sometimes also have additional layers and features such as 3-Dimensional films for regulating the flow of liquid in and out of the pad, functional cuffs to direct the fluid during mopping, and other such features that add to the overall functionality of the mop.

The absorbent layer used in present day mop pads is usually bonded airlaids or other similar materials. Pad constructed of such materials are less fluffy than mop pad made of un-bonded tow fibers and hence are more readily saturated with liquid and need to be drained frequently in order to be used effectively. Additionally, the particulate matter that is cleaned and picked up by the pad during the mopping process blocks the pores of the core making it even less effective.

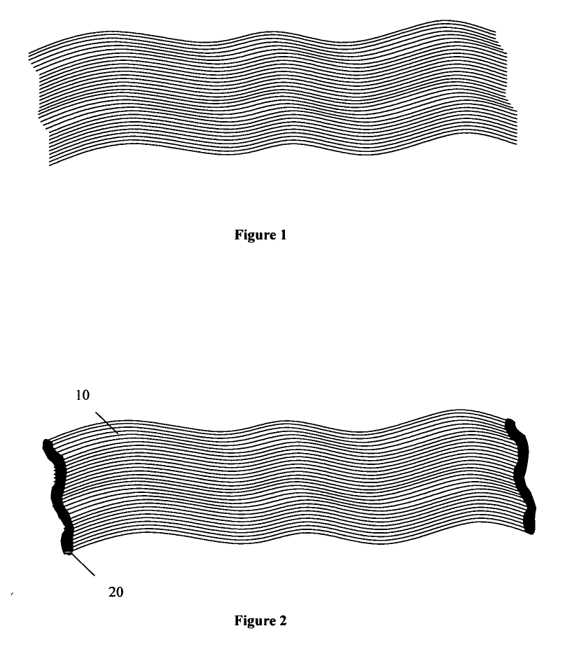

In the instant invention opened tow is used to take care of the aforementioned problems. Tow fibers are opened and made fluffy using conventional techniques such as stretching them along their length and then relaxing, or by using an air-blowing process. The opened tow fibers, which are essentially un-bonded to each other form the raw material for the inventive layer in the cleaning pad disclosed. The preferred embodiment of the invention uses tow that has crimped fibers. One such layer of opened tow is diagrammatically depicted in FIG. 1. Crimping tow fibers gives the fibers a bending point in the air-blowing process

The material used for the tow may be chosen from a wide range of natural and synthetic polymers. The choice of the material is dependent upon the desired properties in the mop such as its longevity or abrasiveness. Some of the materials that can be used to make the tow include polyethene, polyethylene, polypropylene, polyamide, polyester, polylactide, polyvinyl acetate, cellulose acetate, regenerated cellulose such as viscose and rayon and other material exhibiting the desired properties. One may also use bicomponent fibers in which the inner shell is made of a polymer having a high melting point and the outer shell of a polymer having a low melting point. Such fibers have the property that the inner core bonds them and the outer un-bonded layer provides stiffness and resiliency. Polypropylene, polyester and co-polyester are some of the fibers exhibiting high resiliency.

Once a suitable material is chosen and an opened fiber bundle is formed such that all its fibers are substantially oriented in a single direction, (air jet and fiber crimping randomize short fiber sections resulting in a high loft batt) the layer is bonded along its lateral end, securing the fibers in the layer. This bonding can be by use of adhesives, thermal bonding or ultrasonic bonding or any other suitable technique. A unidirectional open fiber layer that is bonded at its extremities is shown in FIG. 2. This layer of open fibers 10 having secured ends 20 can be used as a cleaning pad laminate in the mops. In a pad where this layer is the only layer, it serves the purpose of scrubbing, picking up the scrubbed particles, cleaning and wiping. In the preferred embodiment polypropylene tow is used because of its low cost and ready availability.

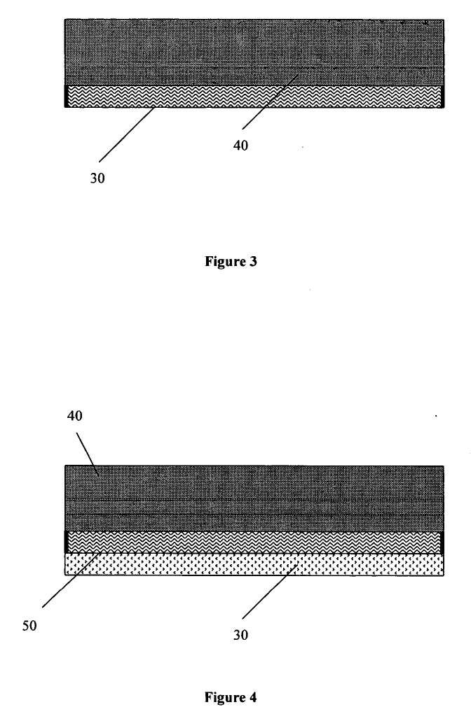

Such a layer can also be used in a multi-layer pad, wherein said layer can be used at different levels, depending upon the need. As shown in FIG. 3, the preferred embodiment can be used as the bottom most layer forming the cleaning surface 30, the other layer being an absorbent layer 40. The materials for the absorbent layer can be chosen from a wide range of conventional materials such as airlaids, wood fibers, polymers and other natural fibers.

If the opened tow is used as the scrubbing layer, then a careful selection of the material should concentrate on parameters such as the abrasive nature of the fibers (as glass would require a much softer fiber as compared to stone), and the desired longevity (once again glass would wear out the fiber much slower than stone). As a scrubbing layer the opened fibers are able to scoop up dirt particles because of the large amount of recesses between the fibers. The particles are held within the layer and do not fall back on the surface to be cleaned. If a washing liquid is used to clean the surface, the layer also serves as a wipe.

FIG. 4 shows another embodiment of the invention in which the tow layer 50 is used between the cleaning surface 30 and the absorbent layer 40. The choice of materials for the absorbent layer and the scrubbing surface would depend upon the application of the mop. The opened tow layer's materials are chosen to suit the needs of a reservoir capillary layer, which absorbs liquid from the surface and gradually transfers it to the absorbent layer. The layer also acts as a collector receptacle for the particulate matter.

The aforementioned are the simple embodiments of the invention. Additional features and enhancement in functionality can be obtained by modifying the tow layer.

For instance bonding patterns may be formed on the pad so as to alter its properties (such as absorption and scrubbing) as well as to add an aesthetic appeal to the product. This is especially true, if the pad is being used as the bottom-most (visible) scrubbing layer.

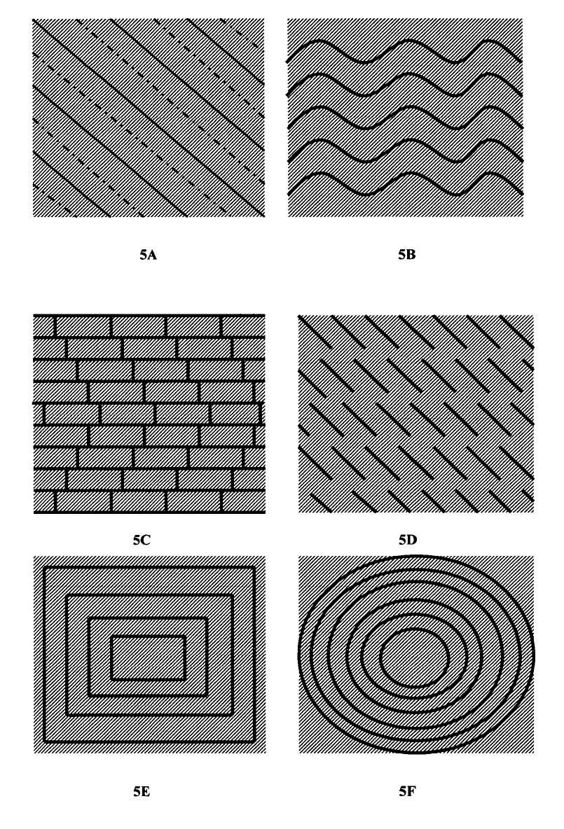

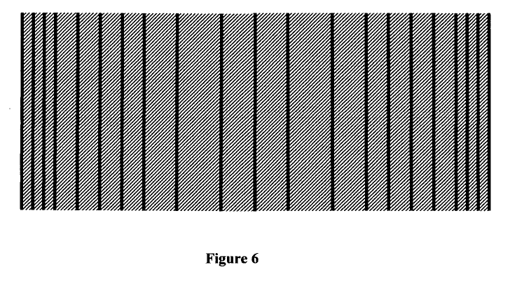

FIG. 5A, 5B, SC, 5D, 5E, 5F show examples the various bonding patterns that can be formed on the opened layer of fibers. The dark lines, solid or dotted, show the bonding lines and the thin lines show the fibers of the tow layer. Although the pattern lines as shown herein are straight lines, curved lines may also be used to form the desired pattern. The density of the bonding lines would determine the volume and thickness of the layer. The density of lines can be varied in different portions of the layer. For example the middle portion that is the predominant wiping portion may have less dense bonding pattern than the peripheral regions thereby increasing its volume. One such arrangement is illustrated in FIG. 6. Furthermore the bonding pattern may be present across the entire length of the absorbent layer or may be localized as per the need of the application. The bonding can be achieved by various techniques known in the field such as thermal or ultrasonic bonding. Since the fibers used are usually polymers, any bonding that uses heat to melt and fuse the fibers together is preferred.

It is also possible to use different thickness of fibers in different regions of the tow layer. This would create desired absorption patterns. One can also choose varying hydrophilicity/hydrophobic nature for the fibers. One may also mix fibers made from two or more different kind of materials so as to accordingly alter the absorption capabilities. For example, dispersing superabsorbent fibers within the tow can increase the absorption capacity.

Since the tow layer can be used for scrubbing particulate matter off the surface, it is also desirable that the layer pick-up the particles and prevents them from being re-deposited back on the surface. One approach is to have a static charge coating on the fibers so that the particles stick to them because of the static energy.

The aforementioned figures and examples are just a few of the embodiments of the instant invention. The figures and examples are illustrative in nature and merely serve to explain the inventive concept. The scope of the invention is much broader. For example, although the invention has been explained focusing on cleaning mops, the cleaning pad laminate as described herein may also be used in household and industrial scrubbers etc.

Various other modifications and alterations are possible within the scope of the invention and the above description does not intend to limit the invention to any particular embodiment. The scope of the invention is only limited by the appended claims.

We claim:

1. An improved cleaning pad laminate for cleaning a surface, comprising at least one layer of opened tow fibers wherein said fibers are oriented in same direction and are bonded together at their lateral edges.

2. The laminate as claimed in claim 1, wherein said layer is a scrubbing layer that touches the surface to be cleaned.

3. The laminate as claimed in claim 1, wherein said layer is an intermediate layer to an absorbent layer of said laminate.

4. The laminate as claimed in claim 1, wherein said tow fiber includes polyethene, polyethylene, polypropylene, polyamide, polyester, co-polyester, polylactide, polyvinyl acetate, cellulose acetate and regenerated cellulose such as viscose and rayon.

5. The laminate as claimed in claim 1, wherein said tow includes a combination of fibers.

6. The laminate as claimed in claim 1, wherein said tow fibers are optionally bonded to each other along their length in one or more or a combination of predetermined pattern.

7. The laminate as claimed in claim 6, wherein said pattern includes straight and curved line patterns including, zig-zag lines, waves, boxes, ellipses and various weaving patterns.

8. The laminate as claimed in claim 6, wherein said bonding includes thermal bonding, air bonding, fusion bonding and ultrasonic bonding.

9. The laminate as claimed in claim 1, wherein the fiber layer thickness is uniform throughout the layer.

10. The laminate as claimed in claim 1, wherein the thickness of the fibers is variable in various sections of the layer.

11. The laminate as claimed in claim 1, wherein the tow is dispersed with fibers of superabsorbent materials.

12. The laminate as claimed in claim 1, wherein said tow is coated with a layer of static charged material.

13. The laminate as claimed in claim 1, wherein said laminate is used in industrial mops, household mops, scrubbing pads and other cleaning equipments.
